(19) United States
(12) Patent Application Publication
(10) Pub. No.: US 2017/0098272 A1
(43) Pub. Date: Apr. 6, 2017

(54) METHOD FOR ADDING ACCESSORIES TO VEHICLES

(71) Applicant: THE REYNOLDS AND REYNOLDS COMPANY, Kettering, OH (US)

(72) Inventors: Robert BROCKMAN, Houston, TX (US); Sidney HAIDER, Houston, TX (US)

(21) Appl. No.: 15/287,350

(22) Filed: Oct. 6, 2016

Related U.S. Application Data
(60) Provisional application No. 62/237,921, filed on Oct. 6, 2015.

(51) Int. Cl. G06Q 30/06; G06F 17/30; G06F 3/0484; G06T 11/60; G06F 3/0482

(52) U.S. Cl. CPC G06Q 30/0643; G06T 11/60; G06F 3/0482; G06F 3/04842; G06F 17/30268; G06F 17/30076; G06Q 30/0625; G06Q 30/0621; G06T 2200/24

(57) ABSTRACT

A method includes determining a specific or basic vehicle, retrieving a base image or modified base image corresponding to the specific or basic vehicle, and selecting an accessory. The method also includes retrieving an accessory image corresponding to the accessory and animating the accessory image onto the base image or modified base image.

### CROSS REFERENCE TO RELATED APPLICATIONS

This application is a nonprovisional application which claims priority from U.S. provisional application No. 62/237,921, filed Oct. 6, 2015, which is incorporated by reference herein in its entirety.

### TECHNICAL FIELD/FIELD OF THE DISCLOSURE

The present disclosure relates generally to computerized methods for adding accessories to vehicles.

### BACKGROUND OF THE DISCLOSURE

A customer for a vehicle may desire to further customize the vehicle by the addition and/or installation of accessories. Retailers may desire a process for managing the process of vehicle customization so as to provide the customer with information regarding the accessories and prices of the accessories. Further, such a process may facilitate purchases of accessories by those clients that might otherwise not occur had such a process not existed.

Traditional processes for presenting information regarding accessories and prices of the accessories have been limited. For instance, a retailer employee may show the customer a picture of the accessory, such as a line drawing, from a paper catalog, magazine, product guide, or digital image. In certain traditional methods, only a list of parts without images was available to the retailer for presentation to a customer regarding accessories. In some traditional processes, the accessory may be shown on a generic vehicle. For example, accessories may be shown to customers from physical copies of catalogs, which may be in some cases out of date or not offered for particular models or years of vehicles. Traditional system have limited, manual systems for determining whether the accessory selected by the customer may be used or available for the vehicle the customer has selected. Also, in traditional methods, the customer would not be able to view the accessory, or, a combination of accessories being selected or considered by the customer, on a vehicle that is the same or similar to the vehicle being purchased or considered for purchase by the customer.

### SUMMARY

The present disclosure provides for a method. The method includes determining a specific or basic vehicle, retrieving a base image or modified base image corresponding to the specific or basic vehicle, and selecting an accessory. The method also includes retrieving an accessory image corresponding to the accessory and animating the accessory image onto the base image or modified base image.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A is a flow chart depicting a customizing vehicle process consistent with at least one embodiment of the present disclosure.

FIG. 1B is flow chart depicting a customizing vehicle process consistent with at least one embodiment of the present disclosure.

FIG. 2 is a depiction of a deal summary consistent with at least one embodiment of the present disclosure.

FIG. 3 is a flow chart depicting an AOA process consistent with at least one embodiment of the present disclosure.

FIG. 4 is a depiction of a vehicle selection GUI 212 make selection consistent with at least one embodiment of the present disclosure.

FIG. 5A is depiction of a year selection GUI consistent with at least one embodiment of the present disclosure.

FIG. 5B is a depiction of a model selection GUI consistent with at least one embodiment of the present disclosure.

FIG. 5C is a depiction of a trim package selection GUI consistent with at least one embodiment of the present disclosure.

FIG. 5D is a depiction of a color selection GUI consistent with at least one embodiment of the present disclosure.

FIG. 6 is a depiction of configurator GUI consistent with at least one embodiment of the present disclosure.

FIG. 7 is a depiction of configurator GUI consistent with at least one embodiment of the present disclosure.

FIG. 8 is a depiction of configurator GUI consistent with at least one embodiment of the present disclosure.

FIG. 9 is a depiction of configurator GUI consistent with at least one embodiment of the present disclosure.

FIG. 10 is a depiction of configurator GUI consistent with at least one embodiment of the present disclosure.

FIG. 11 is a depiction of accessory import GUI consistent with at least one embodiment of the present disclosure.

FIG. 12 is a depiction of an embodiment of AOA computer system consistent with at least one embodiment of the present disclosure.

FIGS. 13A-13C depict modification of a base image with an accessory consistent with at least one embodiment of the present disclosure.

FIGS. 14A-14D depict modification of a base image using dynamic image placement consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

As used herein, a “GUI” is a graphical user interface in which data may be displayed and entered. In certain non-limiting embodiments, the GUIs described below may be customized depending on the device on which they are displayed. For instance, vehicle selection GUI 212 as discussed below may display different information when displayed on a computer terminal screen then when displayed on a tablet or smartphone screen.

As used herein, “Add-On-Auto process” or “AOA process” refers to the process of selection of accessories for a vehicle.

As used herein, “retailer” refers to any seller of vehicles, with a physical presence, such as having a car lot, or a virtual presence, such as a website, or a combination thereof.

As used herein, a “salesperson” refers to any employee of a retailer.

As used herein, “deal” refers to an agreement between a retailer and a customer that includes a specific vehicle and the terms at which the vehicle is sold or leased.

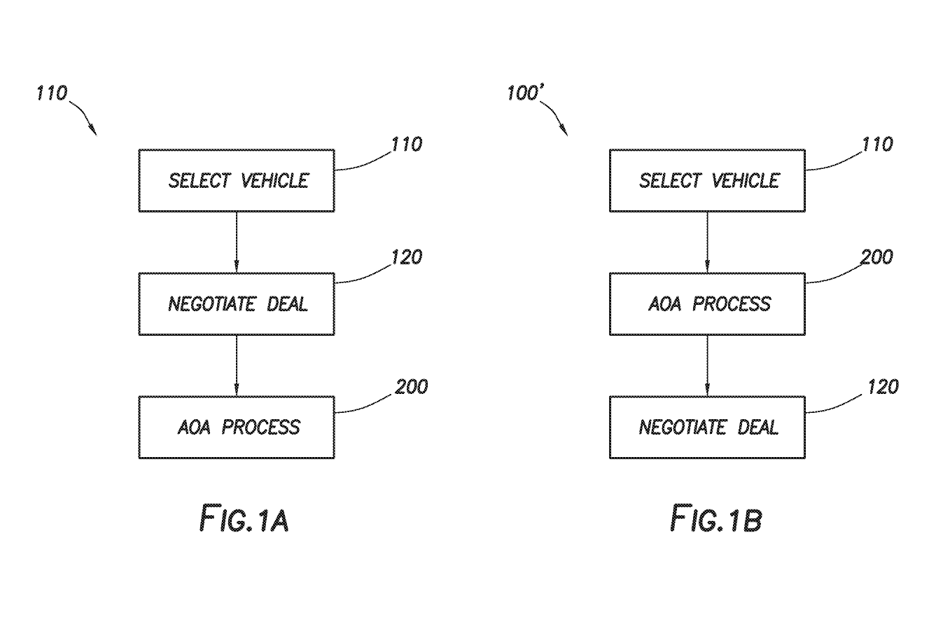

As depicted in FIG. 1A and FIG. 1B, in some embodiments of the present disclosure, customizing vehicle process 100 may include the steps of select vehicle 110, negotiate deal 120, and perform AOA process 200. In select vehicle 110, the customer selects the vehicle he wishes to purchase or is considering purchasing. The vehicle the customer wishes to purchase may be specific, i.e., a vehicle specified by a VIN, or basic, i.e., determined by such aspects as make, model, year, color, and trim package. In certain embodiments, a basic vehicle is designated by at least make, model, and year. Select vehicle 110 may be performed in-person, such as between the customer and a salesperson at a physical site of the retailer, or over a wide-area network such as the internet.

In certain embodiments, as shown in FIG. 1A, after the customer selects the vehicle in select vehicle 110 step, the customer and the retailer negotiate a deal for the car in negotiate deal 120. In other embodiments, as shown in FIG. 1B, after the customer selects the vehicle in select vehicle 110 step, the AOA process is performed in perform AOA process 200. In some embodiments, negotiate deal 120 is omitted. In some embodiments, select vehicle 110 and negotiate deal 120 are omitted, for instance, in an embodiment where a potential customer accesses the AOA process, for instance, through a wide area network such as the internet.

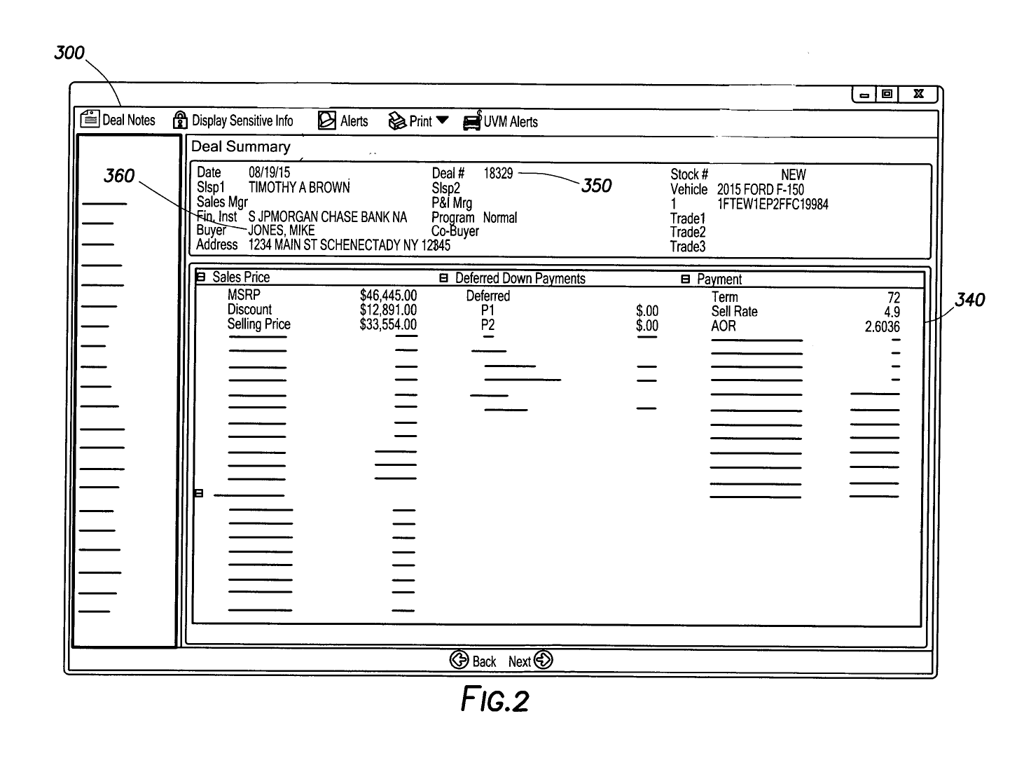

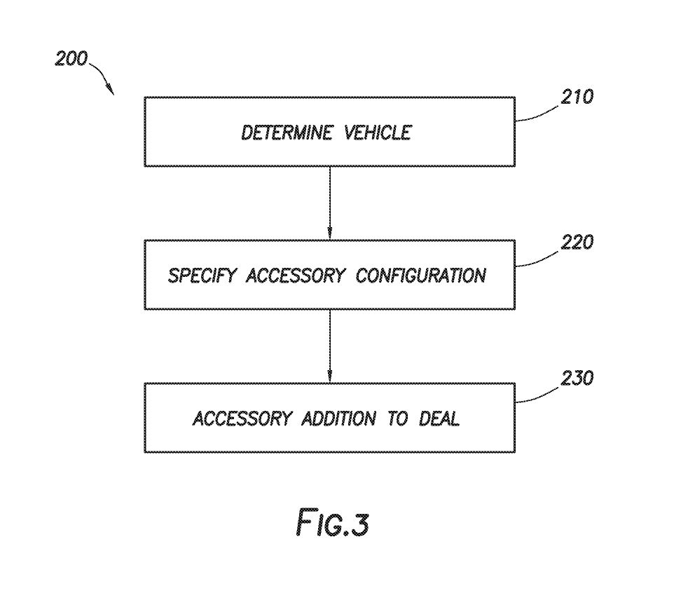

In negotiate deal 120, retailer employees, including for instance the salesperson, sales manager, and others, negotiate with the customer under what terms the customer will purchase the specific vehicle. An example of an online negotiation system that may be used in negotiation process 490 is described in U.S. application Ser. No. 62/061,006, which is fully incorporated by reference. Certain of these terms, as well as information about the customer and the vehicle to be purchased, may be entered into and located in a deal database as part of negotiate deal 120. A deal database is a database on a non-transitory, computer-readable medium in which information and documents regarding deals are stored. Deal summary 300 of such a deal is shown in FIG. 2. Deal summary 300 may include the deal date, salesperson, vehicle identification, which may include the VIN, and deal terms 340, which may include the sales price, any down payment, and financing terms. Deal summary 300 may further include deal number 350, i.e., a unique identifier associated with the deal, and customer identifier 360, which may include the customer's name and address. The deal associated with deal summary 300 may include additional information including, but not limited to, the customer, the retailer and its employees, the vehicle, and the deal terms, some or all of which may be stored in the deal database.

AOA process 200, as depicted in FIG. 3, may include multiple steps. The steps of AOA process 200 may be performed by a computer. For instance, in certain embodiments, AOA process 200 includes the step of determine vehicle 210. Determine vehicle step 210 provides the specific or basic vehicle for use in specify accessory configuration step 220. Determine vehicle 210 may be accomplished through electronic means. For instance, determine vehicle 210 may be accomplished by retrieving information regarding a specific vehicle from the deal database. In other embodiments, determine vehicle 210 may be accomplished by receiving from an input device, including, but not limited to, a keyboard or a mouse, at least the make, model, year, and color of a basic vehicle or the VIN of a specific vehicle.

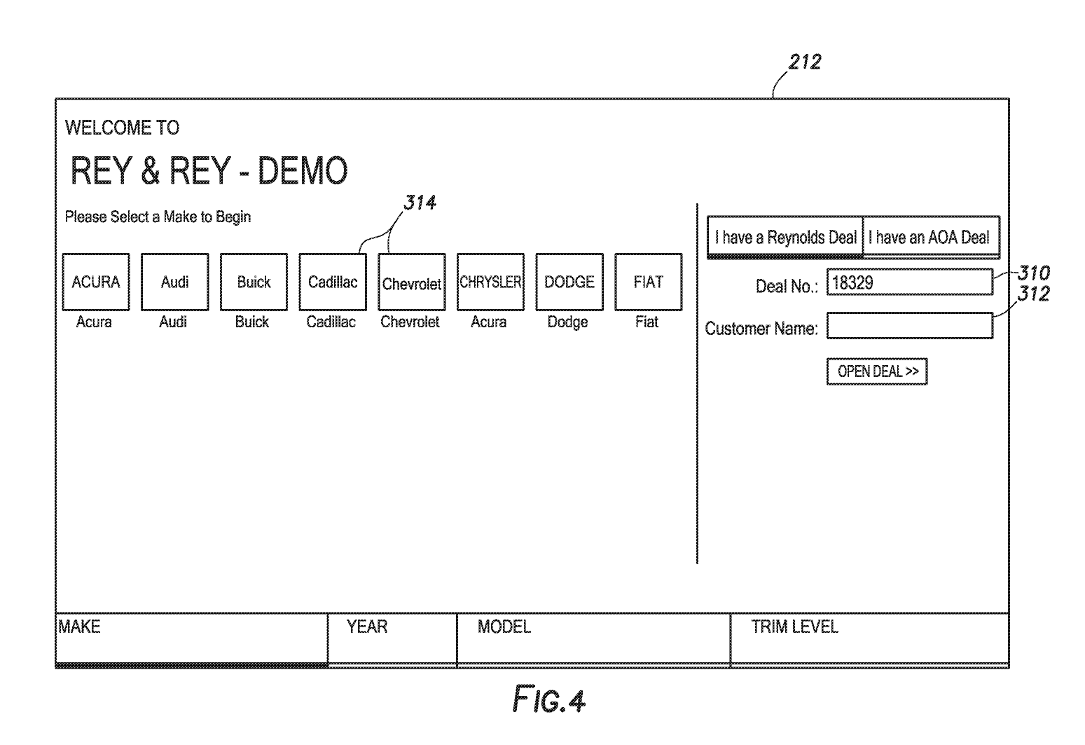

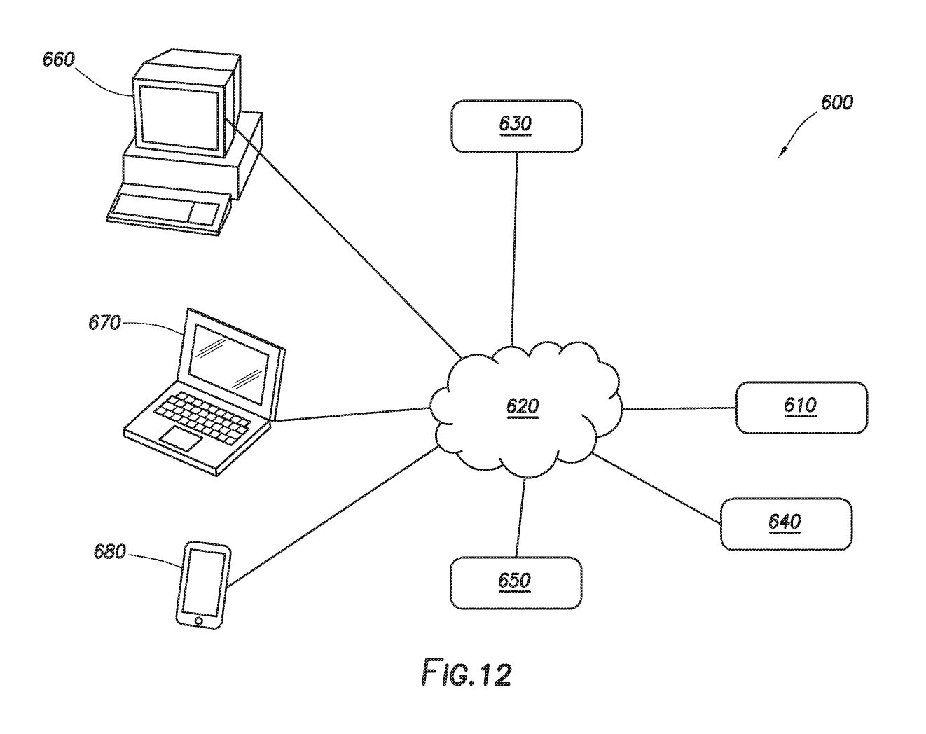

In some embodiments of the present disclosure, as part of the step of determine vehicle 210, vehicle selection GUI 212 as shown in FIG. 4 may be used to enter data to retrieve information regarding the specific vehicle or enter information regarding a basic vehicle. In vehicle selection GUI 212, a deal, such as the deal negotiated in the step of negotiate deal 120 in FIG. 1A, may be selected, for instance, by entering the deal number into deal entry window 310 or the customer name into customer name entry window 312. The deal number or customer name may be transmitted to AOA process server 630, as shown in FIG. 12. By selecting the deal through vehicle selection GUI 212, information regarding the deal, such as the year, make, and model of a specific vehicle may be retrieved from the deal database, such as by AOA process server 630.

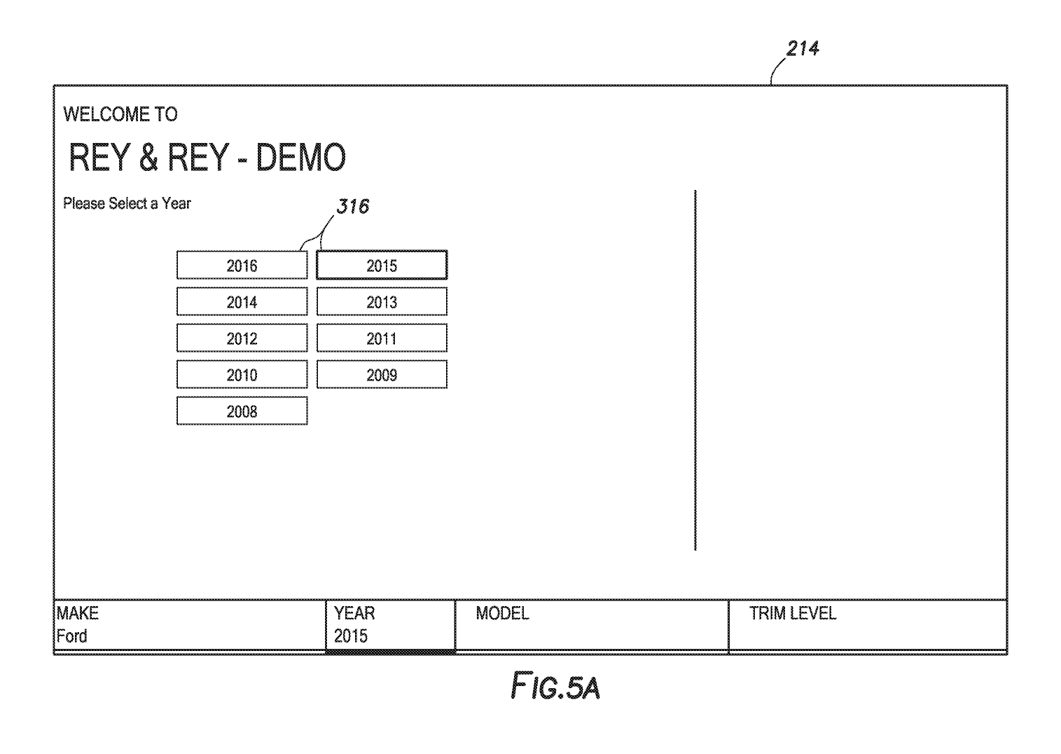

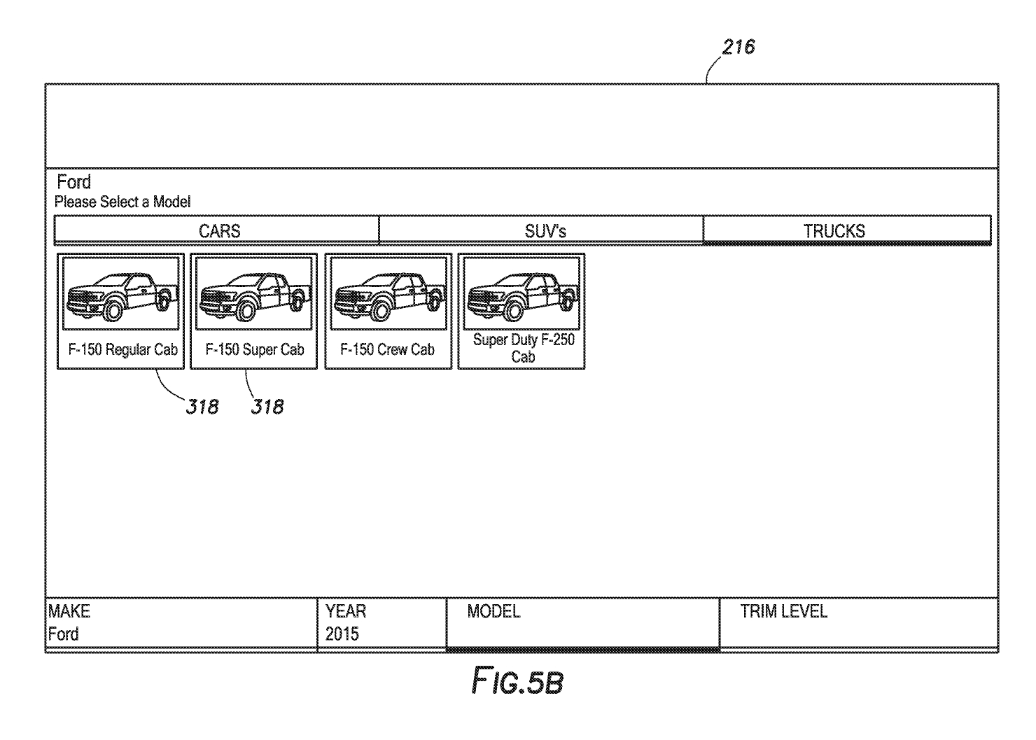

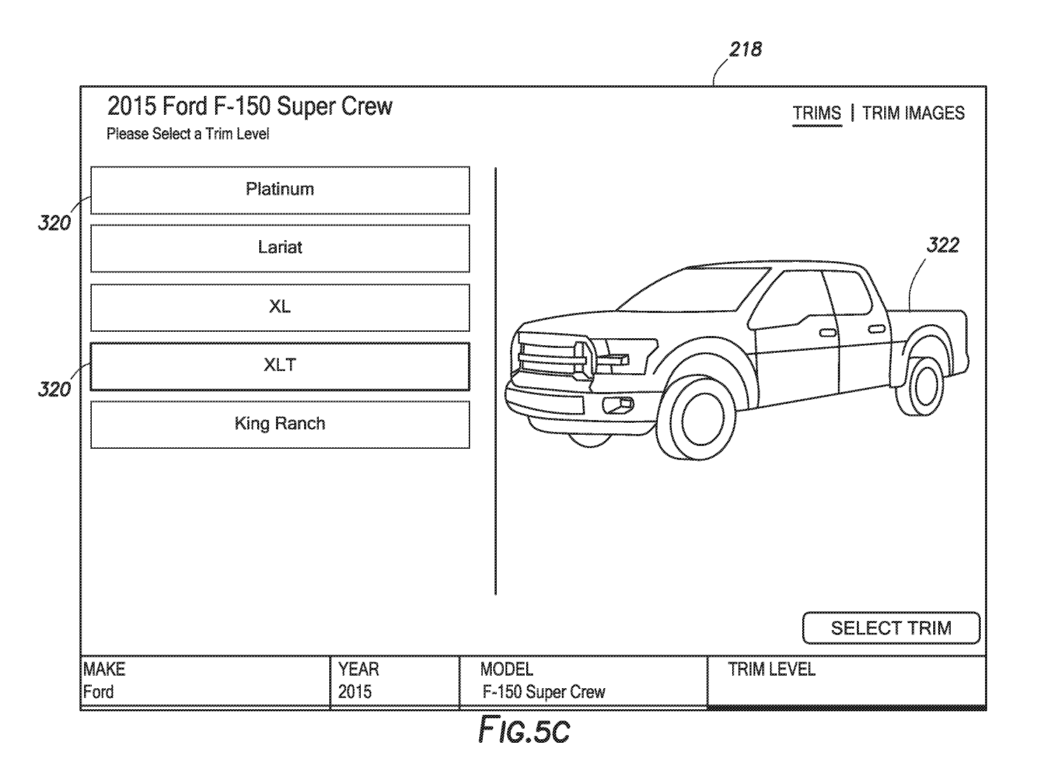

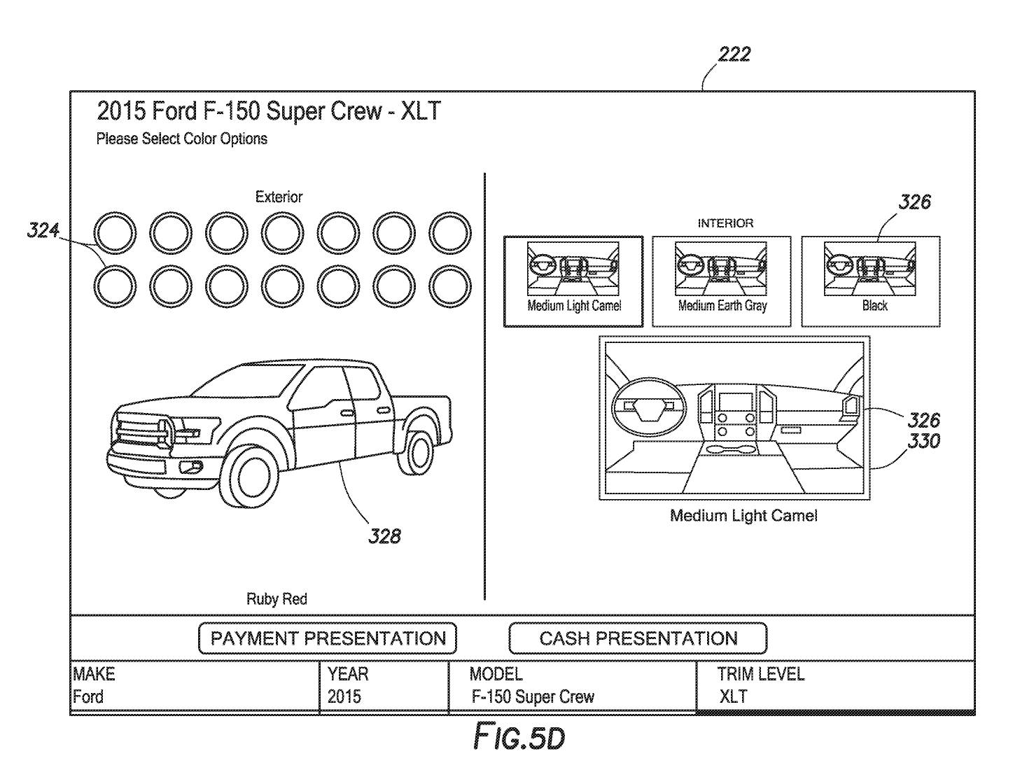

In certain embodiments, data in the deal database may not include the year or model of the specific vehicle. In other embodiments, a customer may wish to examine different makes, models, or years of basic vehicles. In yet other embodiments, the deal may not be completed, as shown in FIG. 1B. In these embodiments, vehicle selection GUI 212, may allow selection of the make of the vehicle through make selection buttons 314. In other embodiments, selection of the make of the vehicle make may be performed by a separate GUI other than vehicle selection GUI The year of the vehicle may be selected in year selection GUI 214, as depicted in FIG. 5A, through year selection buttons 316. The model of vehicle may be selected in model selection GUI 216, as depicted in FIG. 5B, through model selection buttons 318. In certain non-limiting embodiments, model selection buttons 318 may include images of generic vehicle models. “Generic,” as used herein with reference to a vehicle or image, means a vehicle for which make, model, and year have not yet been specified. Images of generic vehicle models may be stored in a vehicle image database, as described hereinbelow.

In some embodiments, the trim package may not be included in the deal database for the specific vehicle or may be specified for a basic vehicle by a customer or retailer employee. As used herein, “trim package” means a set of cosmetic embellishments on a vehicle. In such embodiments, the trim package of the vehicle may be selected, such as with trim package selection GUI 218, as depicted in FIG. 5C, through use of trim selection buttons 320. In certain embodiments, use of a trim selection button 320 may result in display of vehicle image 322 from vehicle image database having the make, model, and trim package selected through vehicle selection GUI 212, year selection GUI 214, model selection GUI 216, and trim package selection GUI 218.

In some embodiments, the exterior and interior colors of the vehicle may not be included in the deal database for the specific vehicle or may be specified for a basic vehicle by a customer or retailer employee. Interior and exterior colors of the vehicle may be selected, such as with color selector GUI 222 through exterior color buttons 324 and interior color buttons 326. In certain embodiments, use of exterior color button 324 may result in display of vehicle image 328 from the vehicle image database having the make, model, trim package, and exterior color selected through vehicle selection GUI 212, year selection GUI 214, model selection GUI 216, trim package selection GUI 218, and color selector GUI 222. In certain embodiments, use of interior color button 326 may result in display of interior vehicle image 330 from the vehicle image database having the make, model, trim package, and interior color selected through vehicle selection GUI 212, year selection GUI 214, model selection GUI 216, trim package selection GUI 218, and color selector GUI 222. Vehicle selection GUI 212, year selection GUI 214, model selection GUI 216, trim package selection GUI 218, and color selector GUI 222 are non-limiting examples and other selection GUIs may be used to select information about the vehicle of the deal.

Once the specific vehicle of the deal or the basic vehicle has been selected, such as by retrieving information regarding the vehicle from the deal database or the deal database in conjunction with the selection GUIs discussed above, only through the selection GUIs discussed above, or by otherwise determining the specific or basic vehicle, the customer in conjunction with retailer employees may specify accessories that may be added to the vehicle as part of the step of specify accessory configuration 220. Non-limiting examples of accessories that may be specified include, but are not limited to body kits, electronics, exterior parts, interior parts, performance accessories, wheel accessories, wheels, and other accessories. Electronics may include alarms, remote starts, amplifiers, speakers, backup camera and sensors, Bluetooth connections, navigation packages, radar detectors, and video accessories. Exterior parts may include armor and rocker protection, bed liners, body side moldings, chrome trim, deflectors, doors, windows, exterior graphics, fender flares, bumpers, grille guards, grilles, hitches, hoods, jeep tops, lighting, roof racks, cargo carriers, bike racks, roof spoilers, side scoops, side skirts, spoilers, step bars, styling bars, sunroofs, tire covers, tires, tonneau covers, bed caps, truck bed accessories, window films and window tinting. Interior parts may include dash kits, floor mats, and upholstery. Performance accessories may include air filters, air intakes, exhaust accessories, and suspension kits. Other accessories may include covers, snow accessories, and winches. One or of ordinary skill in the art with the benefit of this disclosure may envision other accessories that may be specified as part of AOA process 200.

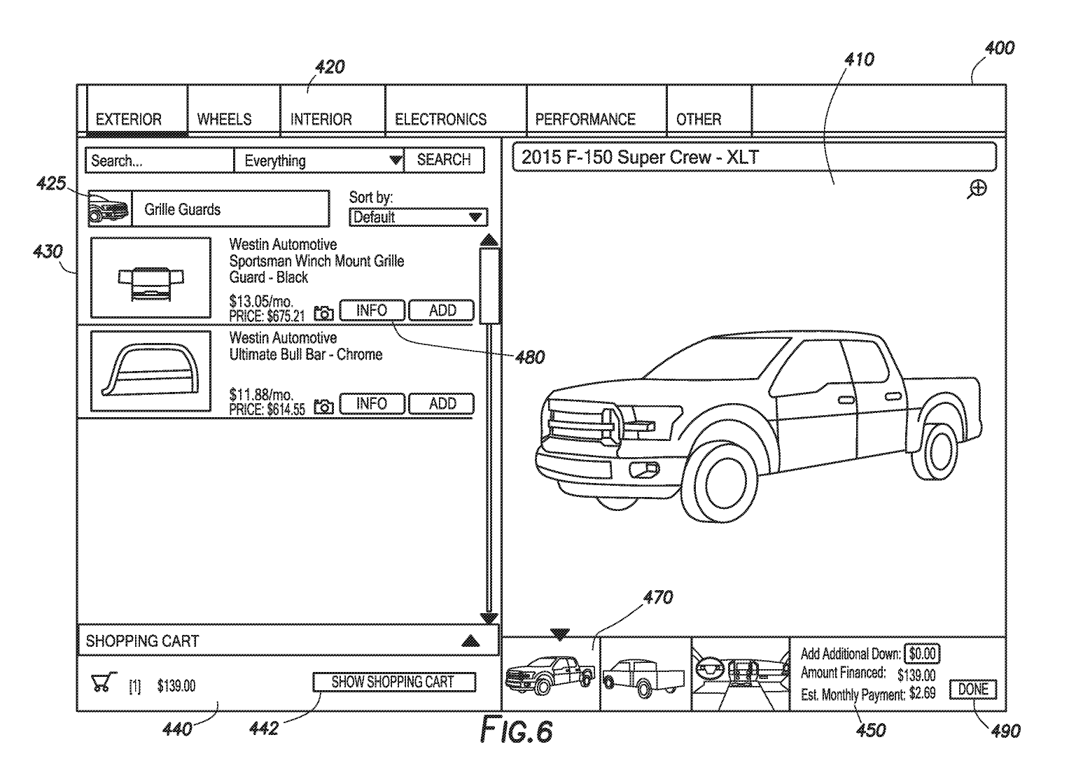

Certain accessories may be specified through the use of configurator GUI 400, as shown in FIG. 6. Configurator GUI 400 may include vehicle animation window 410. Prior to specifying accessories, vehicle animation window 410 may depict the specific vehicle or basic vehicle based on information about the deal from the deal database, vehicle selection GUI 212, year selection GUI 214, model selection GUI 216, trim package selection GUI 218, and color selector GUI 222, other GUIs, or other inputs. Configurator GUI may include accessories list 430. Accessories list 430 may list and/or depict accessories that may be added to the depiction of the specific or basic vehicle in vehicle animation window 410. Access to sets of accessories in accessory list 430 may be controlled by navigation user interface elements such as accessory category user interface elements 420 and accessory elements user interface element 425. Accessory category user interface elements 420 allow a user to decide upon certain categories of accessories, shown in FIG. 6 as exterior, wheels, interior, electronics, performance, and other, although these are examples and other categories are possible. Accessory user interface elements 420 allow a user to select which type of accessory within the categories of accessories the user wishes to consider for depiction in vehicle animation window 410.

The specific or basic vehicle image displayed in vehicle animation window 410 prior to specifying accessories is referred to as a base image or modified base image. In certain embodiments, a base image may be determined by the year, make, model and trim package of the specific or basic vehicle. Base images may be constructed from digital photographs of basic vehicles stored in raw image files, such as a DNG file. In other embodiments, base images of basic vehicles may be supplied by new car manufacturers. In some embodiments, the raw image file may be converted to a layered image file, such as a .PSD file for use in an image manipulation program, such as Adobe PhotoShop. In some embodiments, the base image may be modified to include such features as shadows and highlights.

In some embodiments, base images in a layered image file may be manipulated through the image manipulation program to produce one or more modified base images of a color or trim package different from the original base image. For instance, a base image may be of a pick-up truck having a standard bed. The modified base image may have manipulated to form a digital image of a pick-up truck having a short or long bed. This process of producing modified base images may be repeated for multiple color or trim packages. In some embodiments, the base images and modified base images may include a ¾ front view, a ¾ rear view, an interior view, or a combination thereof.

In certain embodiments, base images and modified base images may be made up of multiple layers, for example and without limitation, between three and seven layers. In a non-limiting example, base images and modified base images may be made up of body and non-body layer, wheel base layer, and rims layer. The body and non-body layer may consist of, for example, the painted area of the vehicle (body) and the non-painted area (non-body), such as the window, grill, headlights, and tail lights. The wheel base layer may consist of, for example the wheels, wheel caliber and shadow of the vehicle. The rims layer may consist only of the rims of the vehicle.

Digital images of accessories may be obtained from such sources as original equipment manufacturers (OEMs), accessory manufacturers, captured from the interne, or captured through digital photography of physical accessories. Digital images of accessories may be converted to an image file suitable for use in an image manipulation application, such as PhotoShop.

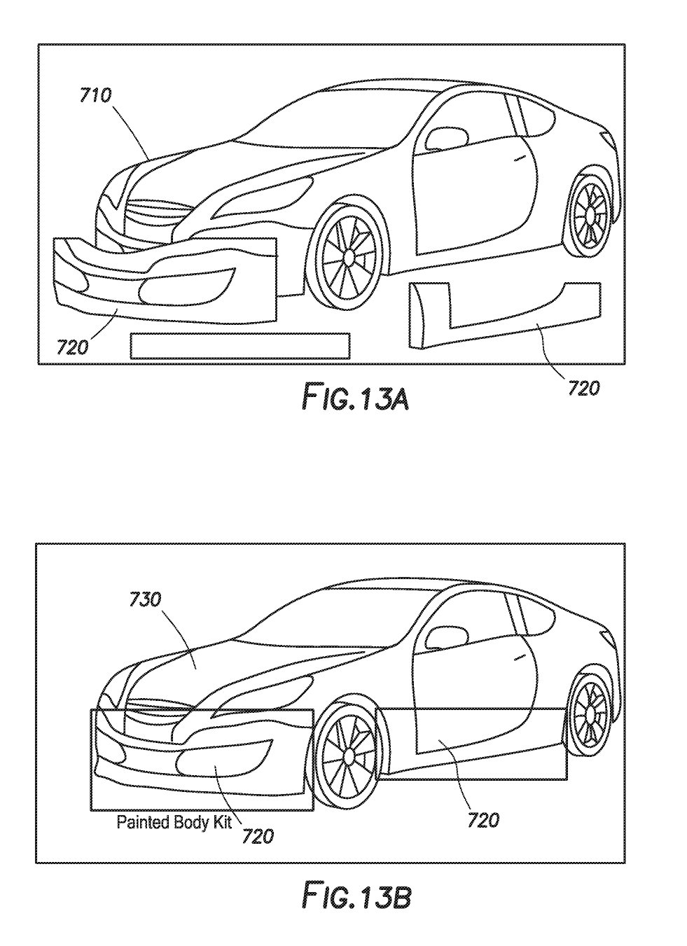

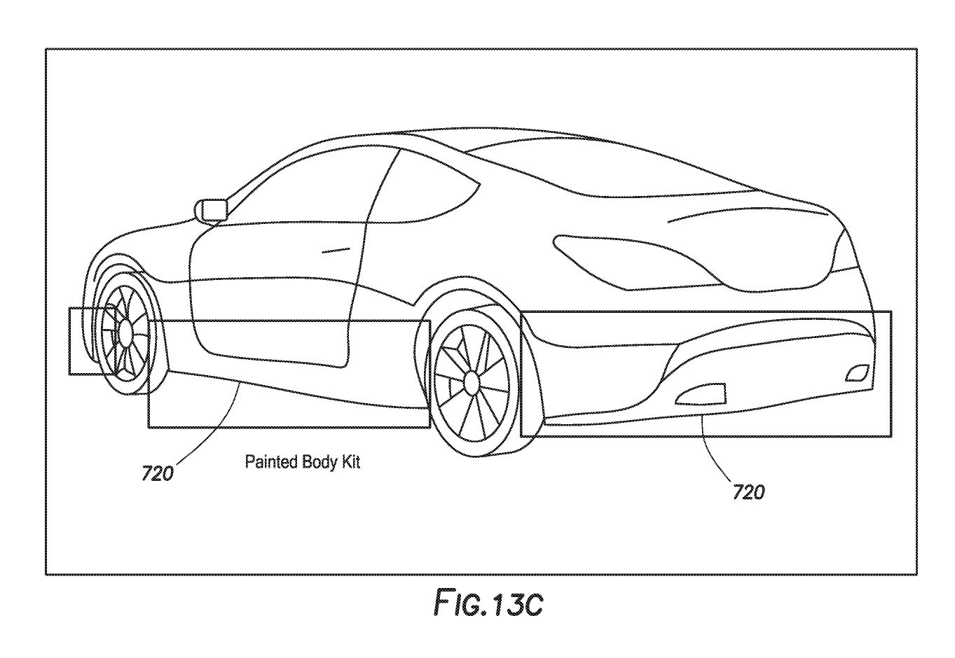

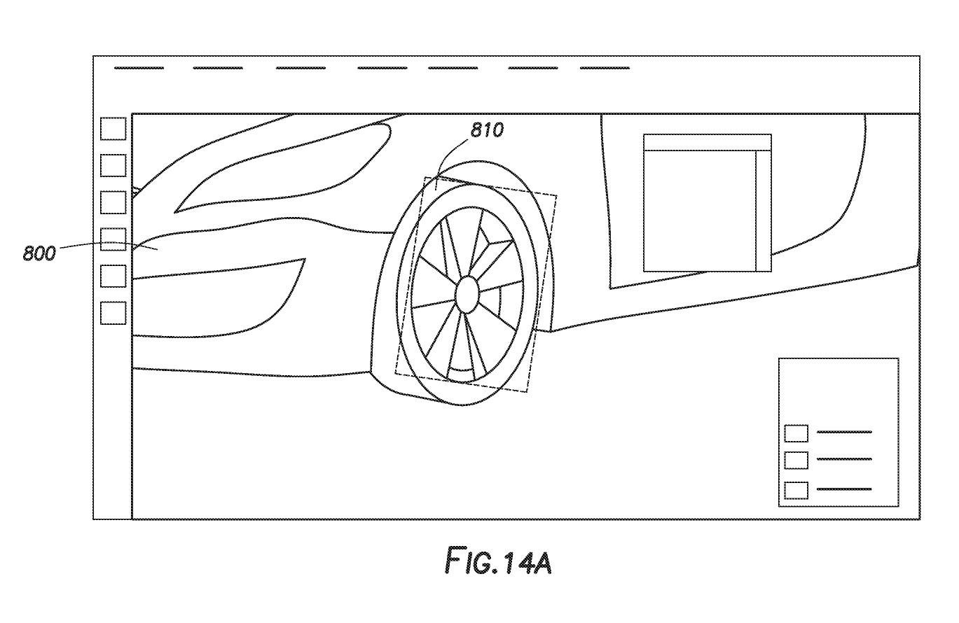

In some embodiments of the present disclosure digital images of accessories may be used to form an overlay. An overlay is an image that may be overlaid onto the base image or modified base image. For example, as shown in FIG. 13A, modified base image 710 is depicted in a ¾ front view together with painted body kit accessory pieces 720. Base image 710 is of a coupe with a particular trim package. As shown in FIG. 13B, the image manipulation program may then form overlay 730, where overlay 730 includes painted body kit accessory pieces 720. Similarly, FIG. 13B depicts the modified base image in ¾ rear view having painted body kit accessory pieces 720 included. FIGS. 13A, 13B and 13C depict the complete modified base image rather than the layers for example only, as may be depicted in vehicle animation window 410 of configurator GUI 400.

When particular accessories are selected in configurator GUI 400, AOA process server 630 may layer the base image with the overlay to form an accessorized image, a process referred to as “animation.” In certain embodiments, multiple overlays with different accessories may be overlaid onto the base image or modified base image to form an accessorized image as the different accessories are selected through configurator GUI 400.

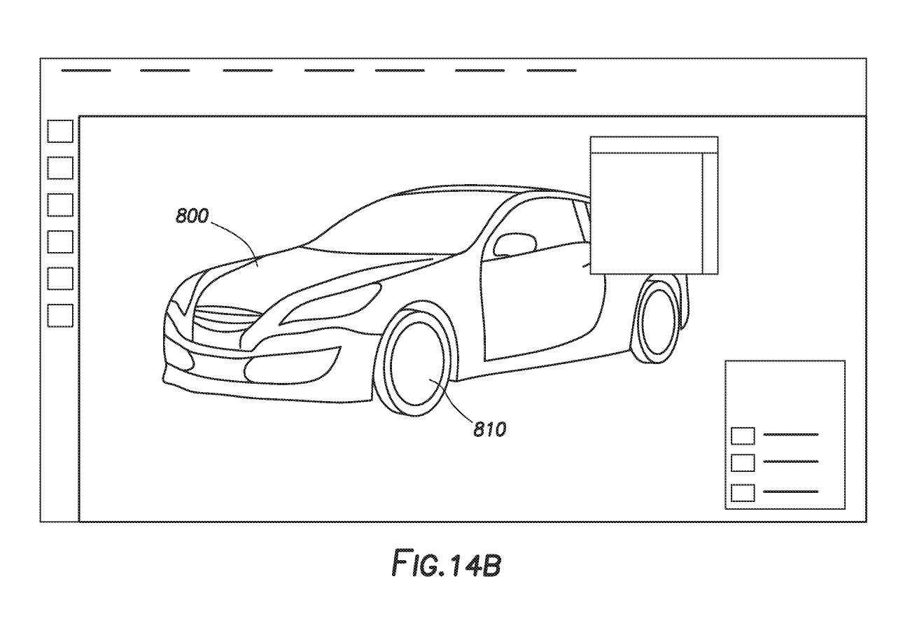

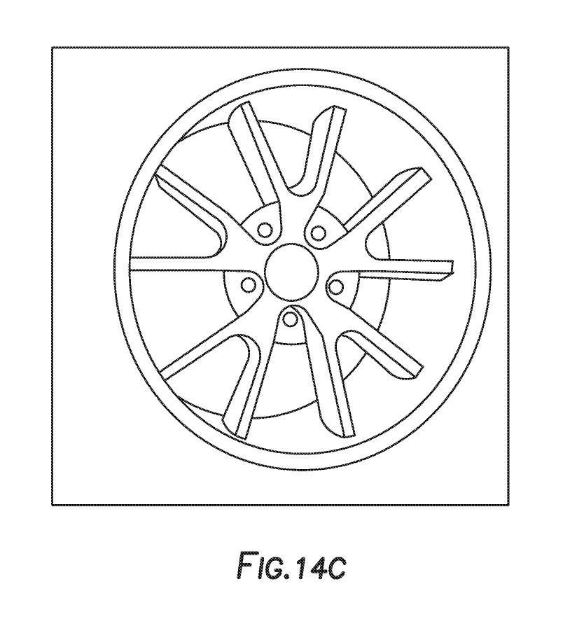

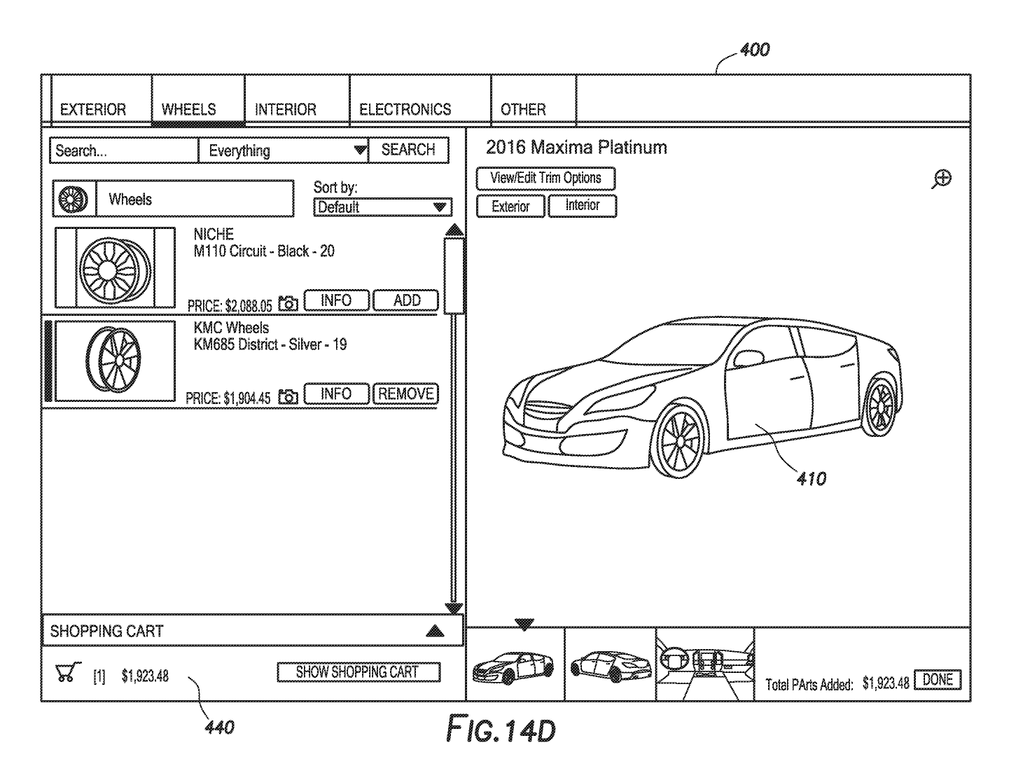

In other embodiments, such as for wheels, rather than form an overlay, AOA process server 630 may use a process referred to herein as dynamic image placement. In dynamic image placement, the base image or modified base image may be mapped at least in part and the portion of on the image where the potential accessory may be positioned is selected. As shown in FIG. 14A, stock rim portion 810 of modified base image 800 is selected. Rather than use an overlay, as shown in FIG. 14B, stock rim portion 810 may be removed from the modified base image. As shown in FIG. 14C, wheel accessory image 820 corresponding to a wheel selectable in configurator GUI 400 may be selected and the wheel accessory 820 may replace the image of stock rim portion 810, as shown in FIG. 14D.

In some embodiments, AOA process server 630 may determine whether two particular accessories may be selected and displayed in vehicle animation window 410 of configurator GUI 400. For instance, if a bumper and a hitch are chosen through configurator GUI 400, AOA process server 630 may determine that overlays exist for each of the bumper and a hitch and the overlays will not interfere with one another, i.e., have pieces of the overlay image that would be occupy the same space on the accessorized image. If the AOA process server 630 determines that the overlays will interfere with each other, the AOA process server 630 may direct configurator 400 to depict only the first accessory chose, only the second accessory chosen, or neither of the accessories chosen in vehicle animation window 410. In certain embodiments, AOA process server 630 may also verify that overlays exist for the accessory.

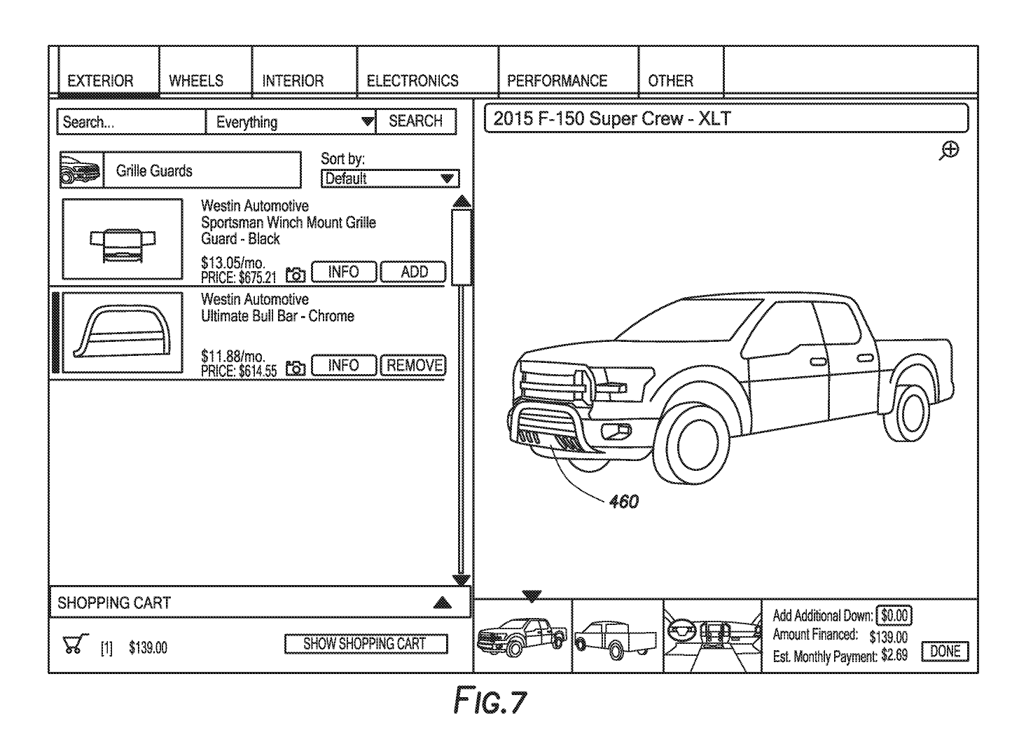

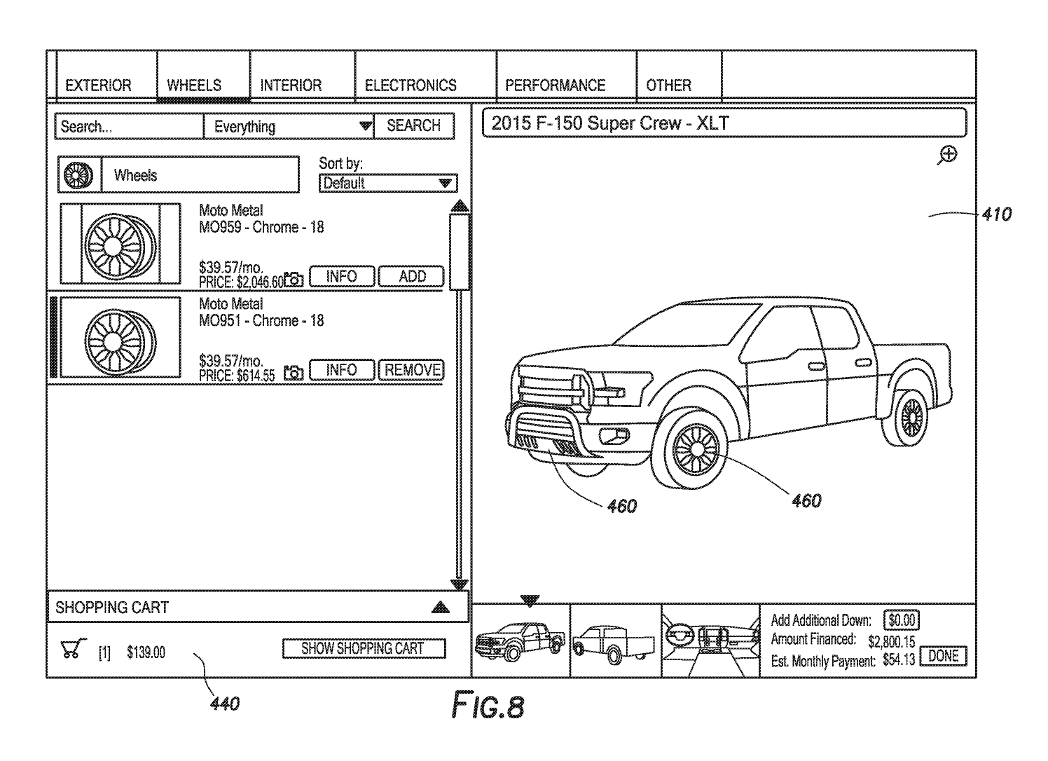

Selection of an accessories from accessory list 430 will animate the selected accessory onto the base image or modified base image of the vehicle depicted in vehicle animation window 410. As shown in FIG. 7, depicted element 460 has been animated onto the original vehicle depiction in vehicle animation window 410. The example shown in FIG. 7 is a bull bar.

With further reference to FIG. 6, configurator GUI 400 may further include accessory tally window 440, entitled “shopping cart.” Accessory tally window 440 may interface with an accessory tally database that tallies what accessories a customer has selected and in certain embodiments the cost of those accessories. Configurator GUI 400 may further include accessory pricing window 450. Accessory pricing window 450 may display the cost of the accessory to the customer, either as an addition to the customer's financed monthly payment, as shown in FIG. 6, or the actual cost of the accessory to the customer. In addition, configurator GUI 400 may include vehicle view user interface elements 470. Vehicle view user interface elements 470 allow the user to change the view of the vehicle in vehicle animation window 410, for instance, to allow the customer to view the vehicle with the animated accessories from a different perspective.

As additional accessories are selected by the customer, these additional accessories are added to the vehicle depiction in vehicle animation window 410. For instance, as shown in FIG. 8, in the addition to the bull bar, depicted elements 460 includes wheels accessories. Accessory tally window 440 further tallies the cost and number of accessories selected by the customer for depiction in vehicle animation window 410.

In certain embodiments, a retailer may choose to group accessories into “packages.” These packages may be selected from accessory list 430 and all, some or none of the accessories in the package may be displayed on the vehicle depiction in vehicle animation window 410. Packages may be specified to simplify part selection. A non-limiting example of such a package includes, a fender package. In certain embodiments, accessory list 430 may include both a right fender and a left fender. A fender package may be listed on the accessory list 430 that includes matching right and left fenders. As another example of a package to simplify part selection could be a roof rack with cross bars. Customers may select a roof rack without realizing that crossbars may not be included in the roof rack. A package may be created that would include both the roof rack and the cross bars. Another category of packages may be a convenience package. A convenience package may include accessories that customers may have in the past selected together or ones in which a user may sell together. Common convenience packages include performance packages towing packages, and body packages. A performance package could include tuning parts, exhaust systems, and cold air intakes. A towing package may include specific mirrors, brake controllers, a bigger radiator than normally specified, a leaf spring in the back of the vehicle, and an increased payload capacity. A body package for a truck might include a grill guard, step bar, and fender flares.

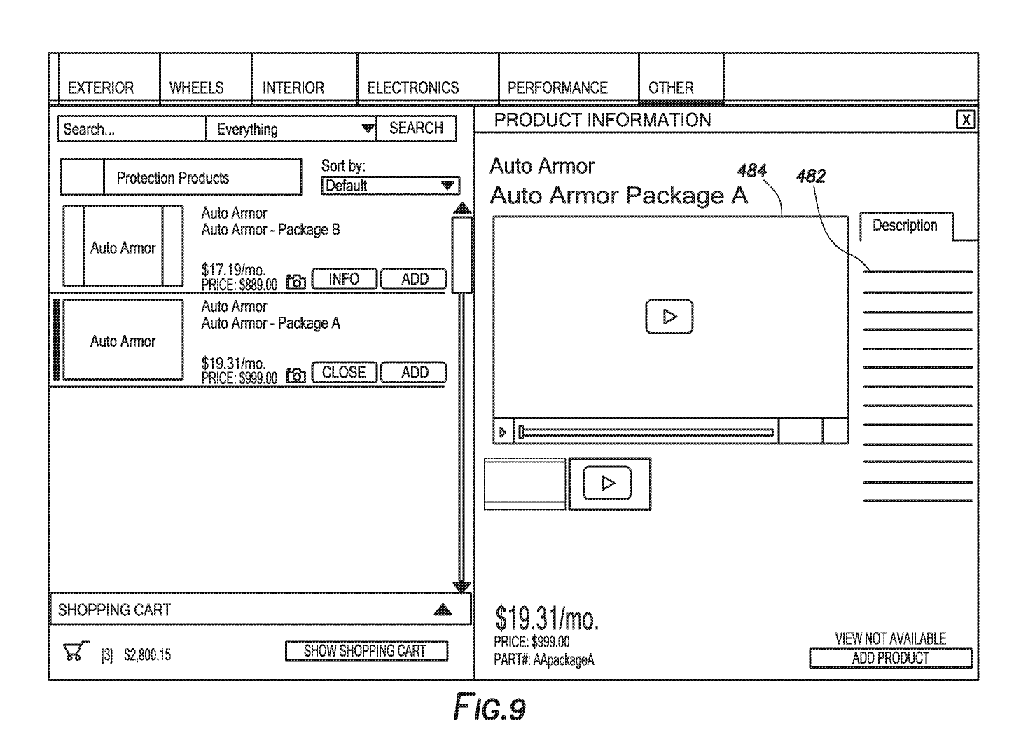

Configurator GUI 400 may further include additional information user interface elements 480. Additional information user interface elements 480 may provide a link to an external database or information system such as the internet that allows additional information to be shown in vehicle animation window 410. FIG. 9 depicts an example of the use of additional information user interface elements 480. As shown in FIG. 9, once selected, additional information user interface elements 480 display at least one media element, such as, for example and without limitation, text information 482 and video 484 in vehicle animation window 410.

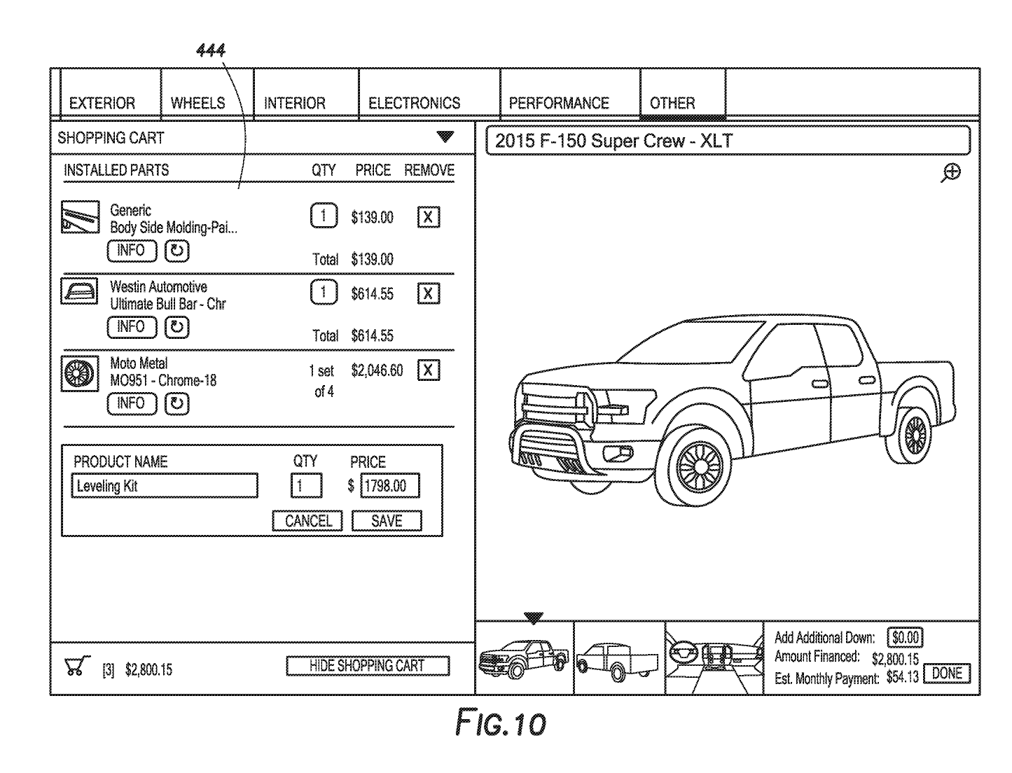

Accessory tally window 440 may include tally review user interface element 442, entitled “view shopping cart” on FIG. 6. Once selected, tally review user interface element 442 accesses and shows tally review window 444, entitled “shopping cart”, as shown in FIG. 10.

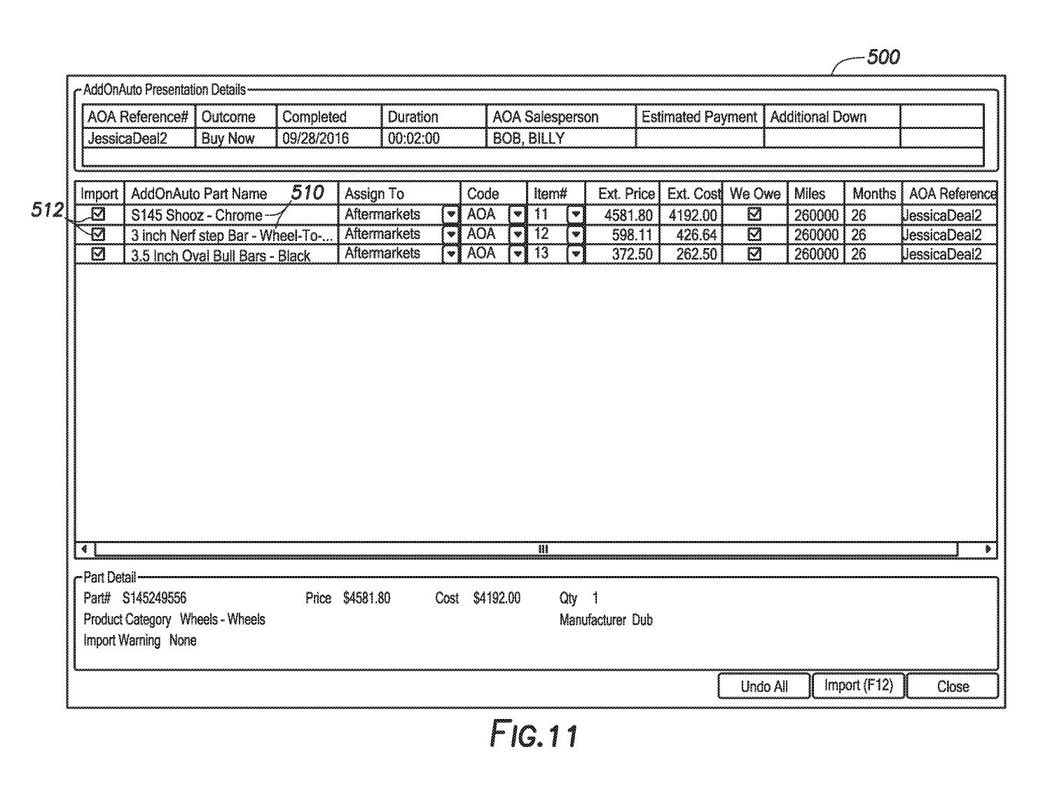

After the customer has completed selection of the accessories through configurator GUI 400, specify accessory configuration step 220 may be completed through selection of accessory completion user interface element 490, entitled “DONE” in FIG. 6. After specify accessory configuration step is completed, as shown in FIG. 3, the AOA process includes accessory addition to deal step 230. As shown in FIG. 11, accessories selected by the customer may be imported into the deal database through accessory import GUI 500. As shown in accessory import GUI 500, accessory display fields 510 may depict accessories selected by the customer prior to importation into the deal database. One or more of the accessories displayed in accessory display fields 510 may to be imported into deal database, for example, by selecting one or more import buttons 512.

In certain embodiments of the present disclosure, after the accessories selected by the customer are imported into the deal database, the accessories selected by the customer may be ordered by the retailer from a third party, such as an accessories vendor, or designated for the customer from existing retailer inventory, such as the retailer's service department. In these embodiments, the customer may be scheduled for service department appointment wherein the accessories selected by the customer are installed. In other embodiments, the accessory may be installed by a third party, such as an accessories installer. In these embodiments, the customer may be scheduled for an appointment for installation of the accessory with the third party, wherein the accessories are installed. As one of ordinary skill in the art with the benefit of this disclosure will appreciate, a combination of these embodiments may be employed, i.e., certain accessories may be installed by the retailer service department and other accessories may be installed by a third party.

Although depicted herein as using buttons in the various GUIs, one having ordinary skill in the art with the benefit of this disclosure will understand that any user interface element may be utilized without deviating from the scope of this disclosure. For example and without limitation, interactive elements may include buttons, drop down lists, radio buttons, check boxes, list boxes, dropdown buttons, toggles, text fields, or sliders, as understood in the art.

FIG. 12 depicts an embodiment of AOA computer system 600 on which customizing vehicle process 100 may be operated. AOA computer system 600 may include deal database server 610. Deal database server 610 may include the deal database in which information and documents regarding deals are stored. In the embodiment shown in FIG. 12, deal database server 610 may be accessed, such as through network 620, by AOA process server 630. Network 620 may include one or more local area or wide area networks. The wide area network may be the internet. AOA computer system 600 may also include vehicle image database server 640. Vehicle image database server 640 may include a vehicle image database on which digital images of basic vehicles are stored on a non-transitory, computer readable medium. Vehicle image database server 640 may be accessed, such as through network 620, by AOA process server 630. AOA computer system 600 may also include accessory database server 650. Accessory database server 650 may include an accessory database on which digital images of accessories are stored on a non-transitory computer readable medium. Accessory database server 650 may be accessed, such as through network 620, by AOA process server 630. In certain embodiments, vehicle image database server 640 and accessory database server 650 may be the same physical server, i.e., the vehicle image database and the accessory database may reside on the same server.

AOA process server 630 may include instructions on a non-transitory, computer readable medium for performing the processes outlined above with respect to AOA process 200, generation and updating of GUI's, presentment of images, and data transmission to and receipt from remote devices 660, 670, 680. In certain embodiments, AOA process server may retrieve all or part of the vehicle image database and the accessory database and store the images on the non-transitory computer readable medium of AOA process server 630. In certain embodiments, retrieval of all or part of the vehicle image database and the accessory database may be performed on a periodic basis. Remote devices 660, 670, 680 include, for example and without limitation, desktop computer 660, lap top computer 670, and mobile device 680.

1. A method comprising:
determining a specific or basic vehicle;
retrieving a base image or modified base image corresponding to the specific or basic vehicle;
selecting an accessory;
retrieving an accessory image corresponding to the accessory; and
animating the accessory image onto the base image or modified base image.

2. The method of claim 1, wherein the step of determining a specific or basic vehicle comprises retrieving information regarding the specific vehicle from a deal database.

3. The method of claim 2, wherein the step of retrieving information regarding the specific vehicle comprises:
generating a vehicle selection GUI;
selecting a deal from the vehicle selection GUI;
retrieving year, make, and model of a specific vehicle from the deal database based on the deal selected from the vehicle selection GUI.

4. The method of claim 1, wherein the step of determining a specific or basic vehicle comprises:
selecting a make, year, model, trim package and color through one or more GUIs;
based on the selections made through the one or more GUIs, determining the specific or basic vehicle.

5. The method of claim 1, wherein the accessory is a body kit, armor and rocker protection, bed liner, body side molding, chrome trim, deflector, door, window, exterior graphics, fender flares, bumpers, grille guards, grills, hitch, hood, jeep top, lighting, roof rack, cargo carrier, bike rack, roof spoiler, side scoop, side skirt, spoiler, step bar, styling bar, tires, tonneau cover, bed cap, window film, window tinting, dash kit, suspension kit, covers, winches and combinations thereof.

6. The method of claim 1, further comprising prior to the step of selecting an accessory:
generating a configurator GUI, the configurator GUI having an accessories list and a vehicle animation window.

7. The method of claim 6, wherein the step of selecting an accessory further comprises:
selecting an accessory from the accessory list.

8. The method of claim 6 further comprising after the step of retrieving a base image or modified base image but prior to the step of selecting an accessory:
displaying a base image or modified base image in the vehicle animation window.

9. The method of claim 8, further comprising prior to the step of retrieving a base image or modified base image:
generating a base image, the base image generated by:
generating a digital photograph of a basic vehicle;
storing the digital photograph in a raw image file;
converting the raw image file to a layered image file.

10. The method of claim 9 further comprising after the step of generating a base image:
generating a modified base image, the modified base image generated by manipulating the base image, wherein the modified base image has a different color or trim package than the base image.

11. The method of claim 10, wherein the base images and modified base images include a ¾ front view, a ¾ rear view, an interior view, or a combination thereof.

12. The method of claim 10, wherein the base image or modified base image comprises a plurality of layers.

13. The method of claim 12, wherein the plurality of layers include a body and non-body layer, a wheel base layer, and a rims layer.

14. The method of claim 12 further comprising:
forming an overlay using an accessory image using an image manipulation program to form an overlay.

15. The method of claim 14, wherein the step of animating the accessory image onto the base image or modified base image comprises layering a first overlay onto the base image or modified base image to form an accessorized image.

16. The method of claim 15 further comprising layering a second overlay onto the accessorized image, the second overlay including a second accessory image.

17. The method of claim 16 further comprising:
selecting a second overlay;
determining if at least a portion of the second overlay image would occupy the same space on the accessorized image;
if at least a portion of the second overlay image would occupy the same space on the accessorized image, displaying only the first overlay, only the second overlay, or neither of the first or second overlay.

18. The method of claim 14, wherein the step of animating the accessory image onto the base image or modified base image comprises:
selecting a portion of a base image or modified base image wherein the accessory image is to be positioned;
removing the portion of the base image;
replacing the portion of the base image with the accessory image.

19. The method of claim 6, wherein configurator GUI includes an accessory tally window, and the method further comprises:
tallying which accessories have been selected and the cost of the accessories.

20. The method of claim 19 further comprising adding the tally of the selected accessories and the cost of the accessories to a deal in a deal database.

21. The method of claim 20 further comprising ordering accessories selected through the configurator GUI from an accessories vendor.
